(19) United States
(12) Patent Application Publication
(10) Pub. No.: US 2003/0104099 A1
(43) Pub. Date: Jun. 5, 2003

(54) Mineral delivery systems and methods

(76) Inventors: Willy W. Lee, Bridgewater, NJ (US); Charlean B. Gmunder, Branchburg, NJ (US); John M. Meyer, Kendell Park, NJ (US)

Correspondence Address: BELL, BOYD & LLOYD LLC, P. O. BOX 1135, CHICAGO, IL, 60690-1135, US

(21) Appl. No.: 10/284,837

(22) Filed: Oct. 31, 2002

Related U.S. Application Data
(63) Continuation-in-part of application No. 09/958,893, filed on Oct. 12, 2001.

(51) Int. Cl. A23G 3/30

(52) U.S. Cl. 426/3

(57) ABSTRACT

The present invention relates to mineral delivery systems and methods. More specifically, the present invention relates to mineral delivery systems and methods that contain an insoluble mineral carbonate and a solid organic acid. When in contact with saliva or other like aqueous solution, the solid acid dissolves and reacts with the mineral carbonate in-situ. The reaction will then convert the water-insoluble mineral carbonate to a soluble mineral organic salt, thus facilitating mineral delivery. The systems and methods of the present invention can employ a variety of different and suitable delivery agents, such as gums or the like.

### CROSS REFERENCE TO RELATED APPLICATIONS

This patent application is a continuation-in-part of U.S. application Ser. No. 09/958,893, filed on Oct. 12, 2001, the disclosure of which is herein incorporated by reference.

### BACKGROUND OF THE INVENTION

The present invention relates generally to systems and methods for mineral delivery. More specifically, the present invention relates to mineral delivery systems and methods that utilize an acid-base reaction between an insoluble mineral carbonate and a solid organic acid.

Conventional gums, such as chewing gums, bubble gums, or the like, include a water-insoluble part, a water-soluble part, and a flavor component. The water-insoluble part is typically referred to as a gum base. The water-soluble part typically includes a number of ingredients, such as sugar, corn syrup, other sweeteners, and/or the like.

Conventional gum bases are made of elastomers, resin tackifiers, vegetable fats, waxes, and mineral texturing agents, such as calcium carbonate and magnesium silicate (talc), the like or combinations thereof. In general, the gum base ingredients, including the mineral texturing agents, are essentially insoluble in saliva, thus providing minimal, if any, nutritional value during chewing.

Of course, minerals are important dietary supplements. For instance, calcium is a major component of bones and teeth. Phosphorus is not only an essential component of bone mineral, it also plays an important role in many and varied chemical reactions. Iron is an essential constituent of hemoglobin. Copper, magnesium, and zinc are co-factors for a variety of enzymes. Manganese and selenium can function as antioxidants and contribute to endothelial integrity. See, Camire & Kantor, Food Chemicals Codex.

To overcome the low water solubility of calcium carbonate, some chewing gums in the marketplace add calcium carbonate to a water-soluble coating on the surface of a gum. When the gum is chewed, the coating binder dissolves, and the calcium carbonate particles are ingested.

For instance, U.S. Pat. No. 4,238,475 (“'475 Patent”) discloses a method of releasing finely divided water-insoluble therapeutic substances from chewing gums. In general, the insoluble active ingredients are encapsulated in a coating with a water-soluble binder. Upon chewing, the binder dissolves, thus causing ingestion of the insoluble particles that includes minerals, such as di-calcium phosphate, magnesium hydroxide, and calcium carbonate, as disclosed. The water-soluble binders include, for example, gum arabic, gum tragacanth, gelatin, pectin, carboxymethyl cellulose, alginate. U.S. Pat. No. 4,867,989 discloses a slightly different technique than the '475 Patent where the coating includes corn syrup.

U.S. Pat. Nos. 4,681,766 and 4,786,511 apply the coating approach to soluble calcium. As disclosed, the preferred water-soluble calcium is calcium chloride, and the preferred binders are gum arabic and xylitol. Xylitol can also provide a desirable and crunchy characteristic when chewed.

In a different approach, U.S. Pat. No. 5,645,853 discloses a process that can facilitate remineralization of lesions in teeth. The active ingredients are water-soluble calcium and phosphates. These ingredients are individually encapsulated with a hydrocolloid coating prior to incorporation into chewing gums in order to prevent undesirable reactions before chewing.

Similarly, U.S. Pat. No. 5,037,639 discloses methods and compositions for mineralizing calcified tissues. The process relates to the use of amorphous calcium compounds, such as amorphous calcium phosphate, amorphous calcium phosphate, fluoride, and amorphous calcium carbonate phosphate, in remineralizing teeth. The amorphous calcium compounds can be incorporated into chewing gums.

U.S. Pat. No. 5,059,416 also discloses a zinc delivery system. To reduce the bitter taste of certain zinc compounds, they are first coated with a hydrophilic coating, then encapsulated in a hydrophobic material, such as a fat or a wax.

A need, therefore, exists to provide improved methods and systems for mineral delivery, such as, methods and systems that employ gums capable of releasing one or more minerals during use.

### SUMMARY OF THE INVENTION

The present invention relates to mineral delivery systems and methods, such as gums capable of releasing one or more minerals during use. In general, the mineral delivery systems and methods employ at least two active ingredients, namely a mineral carbonate and an acid. Preferably, the active ingredients are in a solid form, such as in a powder. During use, the mineral carbonate reacts with the acid via an acid-base reaction in an aqueous solution, such as with saliva during chewing of gum that includes the active ingredients. This reaction is desirable as it can solubilize at least a portion of the insoluble mineral salt (e.g., mineral carbonate). In this regard, the soluble mineral is readily available, such as in an individual's oral cavity, thus providing added and beneficial levels of nutrition during use.

A number of different and suitable mineral salts and acids can be effectively utilized. In an embodiment, the acid-base neutralization between calcium carbonate and adipic acid is illustrated as follows:

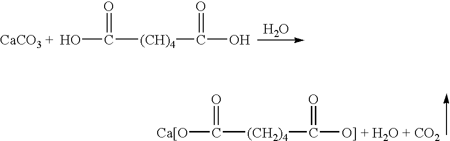

As applied to gum-based mineral delivery systems, the mineral salt and acid components can be incorporated into a gum base of the gum. Preferably, the acid component is in a solid state, such as a fine powder. This is important because it can effectively prevent an acid-base reaction between the acid and the mineral salt prior to use, thus preventing loss of flavor due to same. Once in use, the gum, for example, is capable of releasing one or more minerals via the acid-base reaction between the mineral salt and the acid in an aqueous solution, such as saliva.

To this end, in an embodiment, the present invention provides a mineral delivery system. The mineral delivery system includes a mineral delivery agent capable of releasing one or more minerals via an acid-base reaction between a mineral salt and an acid in an aqueous solution.

In an embodiment, the mineral delivery agent includes a gum, the like or combinations thereof.

In an embodiment, the mineral delivery agent is incorporated into an oral patch.

In an embodiment, the mineral salt is water-insoluble and/or the acid is a solid organic acid. Each component can include a variety of different materials. For example, the mineral salt, in an embodiment, can include mineral carbonates such as, calcium carbonate, copper carbonate hydroxide, magnesium carbonate hydroxide, manganese carbonate, zinc carbonate, zinc carbonate hydroxide, the like or combinations thereof. The acid can include adipic acid, citric acid, fumaric acid, gluconic acid, lactic acid, malic acid, succinic acid, tartaric acid, the like or combinations thereof.

In an embodiment, the mineral delivery agent includes the mineral salt in an amount ranging from about 0.1% by weight to about 60% by weight.

In an embodiment, the mineral delivery agent includes the acid in an amount ranging from about 0.1% by weight to about 30% by weight.

In an embodiment, the mineral delivery agent is in a fine powder form, such as having an average particle size ranging from about 0.1 microns to about 200 microns.

In an embodiment, the acid is in a fine powder form, such as having an average particle size ranging from about 0.1 microns to about 500 microns.

In another embodiment, the present invention provides a mineral delivery system. The mineral delivery system includes a gum that at least includes a mineral carbonate and an acid. This can allow the gum to release one or more minerals into an individual's oral cavity via an acid-base reaction between the mineral carbonate and the acid during chewing of the gum.

In yet another embodiment, a method of releasing one or more minerals into an individual's oral cavity is provided. The method includes the steps of providing a mineral delivery agent including a mineral salt and an acid; placing the mineral delivery agent in the individual's oral cavity; and releasing the minerals via an acid-base reaction between the mineral salt and the acid in an aqueous solution.

Additional features and advantages of the present invention are described in, and will be apparent from, the following Detailed Description of the Invention.

### DETAILED DESCRIPTION OF THE INVENTION

The present invention relates generally to mineral delivery systems and methods. In particular, the systems and methods of the present invention employ an insoluble mineral salt, such as mineral carbonate, and a solid organic acid. These components can be incorporated in any suitable way into a variety of different agents, devices, and/or the like, for suitable use in the mineral delivery systems and methods.

In this regard, the insoluble mineral carbonate and solid organic acid act as active ingredients of the systems and methods of the present invention. When in contact with saliva, water, and/or other aqueous solution, the solid acid readily dissolves and thus can react with the mineral carbonate in-situ. This reaction mechanism converts the saliva-insoluble mineral carbonate into a soluble mineral organic salt. This conversion process is illustrated below as follows:

MCO₃(insoluble)+HOOC—R(in presence of water) [symbol] M[OOC—R]₂(soluble)+H₂O+CO₂↑

The mineral delivery systems and methods of the present invention can be carried out in any suitable way. In general, the solid organic acid and mineral carbonate active ingredients are provided in a suitable mineral delivery agent, such as gum, including chewing gum, bubble gum, confectioneries, such as lozenges, chewy candies, mints, and/or the like. The mineral delivery agent can be used on its own or it can be incorporated into any suitable mineral delivery devices, such as an oral patch, edible films or the like. The oral patch can be made of any suitable material such that upon contact with water, saliva or other aqueous solution an effective amount of minerals can be released from the oral patch that at least contains the active mineral salt and acid ingredients as discussed above.

As previously discussed, the mineral delivery systems and methods of the present invention employ a controlled acid-base reaction between a mineral salt and an acid. In an embodiment, the mineral salt includes a water-insoluble mineral salt, such as mineral carbonate, calcium carbonate, copper carbonate hydroxide, magnesium carbonate hydroxide, manganese carbonate, zinc carbonate, zinc carbonate hydroxide, other like carbonates or combinations thereof. In an embodiment, the acid includes a solid organic food acid, such as adipic acid, citric acid, fumaric acid, gluconic acid, lactic acid, malic acid, succinic acid, tartaric acid, other suitable acids or combinations thereof.

The active components of the mineral delivery systems and methods of the present invention can be provided in a variety of different and suitable amounts, shapes, sizes, and configurations. They may also be encapsulated to delay release and control interaction. In an embodiment, the amount of insoluble mineral salt ranges from about 0.1% by weight of the mineral delivery agent to about 60% by weight of the mineral delivery agent. As previously discussed, the mineral delivery agent can include, for example, gum, or other suitable agents used on its own or incorporated within a suitable delivery device, such as an oral patch.

In an embodiment, the amount of acid within the mineral delivery system of the present invention includes about 0.1% by weight to about 30% by weight of the mineral delivery agent. Preferably, the amount of acid ranges from about 0.5% to about 5% by weight.

As previously discussed, the active ingredients can be sized, shaped and configured in a variety of suitable ways. For example, the insoluble mineral salt and acid components can be provided in the form of a powder, preferably a fine powder. In an embodiment, the insoluble mineral salt in powder form has an average particle size ranging from about 0.1 microns to about 200 microns. Preferably, the average particle size of the insoluble mineral salt ranges from about 0.1 microns to about 20 microns. In an embodiment, the solid acid has an average particle size ranging from about 0.1 microns to about 500 microns. Preferably, the average particle size of the solid acid ranges from about 0.1 microns to about 50 microns.

As previously discussed, the active mineral delivery ingredients of the present invention can be incorporated into a variety of suitable and different mineral delivery agents, delivery devices, the like or combinations thereof. For example, the active ingredients can be incorporated into a gum, including chewing gum, bubble gum, or the like. The mineral salt and solid acid components of the present invention can be added to the gum in a variety of suitable ways. In an embodiment, the mineral salt can be included as a part of the gum base. Alternatively, the mineral carbonate can be added to the gum at a final processing stage, such as after the gum base, flavor and/or other ingredients have been mixed and/or further processed. With respect to the acid component, this too can be added to the gum base of the gum and added to the gum at the final process stage. In an embodiment, the solid acid is added as a flavor component to the processed gum.

The gum made pursuant to an embodiment of the present invention can include a number of suitable and different ingredients in addition to the active ingredients that promote delivery of minerals discussed above.

In general, a gum composition typically includes a water-soluble bulk portion, a water-insoluble gum base portion, and a flavoring agent. The water-soluble portion dissipates with a portion of the flavoring agent over a period of time during chewing. The gum base portion is retained in the mouth throughout the chew. As used herein, the term “gum,” or other like terms, refers to chewing gums, bubble gums or other suitable gums as typically known.

The water-insoluble portion of the gum in this invention may contain any combination of elastomers, resin tackifiers, waxes, fats, mineral fillers, and other optional ingredients, such as colorants and antioxidants.

The variety of gum base ingredients typically used provides the ability to modify the chewing characteristics of gums made from the gum base. Elastomers provide a rubbery and cohesive nature of the gum. This can vary depending on the ingredient's chemical structure and how it may be compounded with other ingredients. The resin tackifiers regulate the cohesiveness and tackiness of the final gums. They are typically either glycerol ester of rosins, or terpene resins derived from alpha-pinene, beta-pinene, d-limonene or mixtures thereof. Waxes aid in the curing of gum bases and can improve shelf-life and texture. Wax crystal can also improve the release of flavor.

Fats modify the texture of the gum base by introducing sharp melting transition during chewing. Fats suitable for use in the gum base and gum of the present invention include triglycerides of non-hydrogenated, partially hydrogenated and fully hydrogenated cottonseed, soybean, palm, palm kernel, coconut, safflower, tallow, cocoa butter, medium chained triglycerides, the like or combinations thereof. Fillers used in gum base modify the texture of the gum base and can aid in processing. Fillers that are suitable for use in the gum base and gum of the present invention include carbonate or precipitated carbonated types, such as magnesium and calcium carbonate, ground limestone and silicate types, such as magnesium and aluminum silicate, clay, alumina, talc, as well as titanium oxide, mono-, di- and tricalcium phosphate, cellulose polymers, such as ethyl, methyl and wood or mixtures, the like or combinations thereof. The fillers can also be organic powders, such as polystyrene, polyethylene, oat fiber, wood fiber, apple fiber, zein, gluten, gliadin, casein, the like or combinations thereof. Flavorants and colorants impart characteristics or remove or mask undesired characteristics. Colorants may typically include FD&C type lakes, plant extracts, fruit and vegetable extracts and titanium dioxide. Flavorants may typically include cocoa powder, heat-modified amino acids and other vegetable extracts.

Gum bases are typically prepared by adding an amount of the elastomer, resin tackifier, and filler to a heated (50-240° F.) sigma blade mixer. The initial amounts of ingredients that make up the initial mass may be determined by the working capacity of the mixing kettle in order to attain a proper consistency and by the degree of compounding desired to break down the elastomer and increase chain branching. By increasing compounding time, and/or, the use of lower molecular weight or softening point gum base ingredients, the lower the viscosity and firmness of the final gum base. Specific examples of the gum base made in accordance with an embodiment of the present invention are described in greater detail below. In general, the gum base includes about 10% by weight to about 95% by weight of the gum.

The water-soluble portion of the gum may include softeners, sweeteners, flavoring agents, the like, and combinations thereof. The sweeteners often fill the role of bulking agents in the gum. The bulking agents generally include from about 5% by weight to about 90% by weight, preferably from about 20% by weight to about 80% by weight of the gum.

Softeners can be added to the gum in order to optimize its chewability and mouth feel. Softeners typically constitute from about 0.5% by weight to about 25.0% by weight of the gum. Softeners contemplated for use in the gum include, for example, glycerin, lecithin, the like, and combinations thereof. Further, aqueous sweetener solutions such as those containing sorbitol, hydrogenated starch hydrolysates, corn syrup, the like, and combinations thereof may be used as softeners and bulking agents in gum. Sugar-free formulations are also typical.

Sugar sweeteners generally include saccharide-containing components commonly known in the gum art which include, but are not limited to, sucrose, dextrose, maltose, dextrin, dried invert sugar, fructose, levulose, galactose, corn syrup solids, the like, or combinations thereof.

The sweetener can also be used in combination with sugarless sweeteners. Generally, sugarless sweeteners include components with sweetening characteristics but which are devoid of the commonly known sugars. The sugarless sweeteners include, but are not limited to, sugar alcohols such as sorbitol, mannitol, xylitol, hydrogenated starch hydrolyzates, maltitol, the like, or combinations thereof.

Depending on the particular sweetness release profile and shelf-life stability needed, bulk sweeteners can also be used in combination with coated or un-coated high-intensity sweeteners or with high-intensity sweeteners coated with other materials and by other techniques.

High-intensity sweeteners, or artificial sweeteners and peptide sweeteners as they may be referred to, typically may include, but are not limited to, alitame, thaumatin, aspartame, sucralose, acesulfame, saccharin, dihydrochalcones, the like, or combinations thereof. The range of these sweetener types in gum in an embodiment ranges from about 0.02 weight percent to about 0.10 weight percent for sweeteners, such as alitame, thaumatin, dihydrochalcones, and the like, and from about 0.1 weight percent to about 0.3 weight percent for sweeteners, such as aspartame, sucralose, acesulfame, saccharin or the like.

The gum of the present invention, in an embodiment, can include a flavoring agent in an amount ranging from about 0.1 weight percent to about 10.0 weight percent, preferably from about 0.5 weight percent to about 3.0 weight percent of the gum. The flavoring agent can include essential oils, synthetic flavors, or mixtures thereof including, but not limited to, oils derived from plants and fruits such as citrus oils, fruit essences, peppermint oil, spearmint oil, clove oil, oil of wintergreen, anise and the like. Artificial flavoring components are also contemplated for use in gums of the present invention. Those skilled in the art will recognize that natural and artificial flavoring agents may be combined in any sensory acceptable blend. All such flavors and flavor blends are contemplated for use in gums of the present invention.

Optional ingredients such as colors, emulsifiers and pharmaceutical agents may be added to the chewing gum.

In general, the gum of the present invention is manufactured by sequentially adding the various gum ingredients in any suitable order to a commercially available mixer known in the art. After the initial ingredients have been thoroughly mixed, the gum mass is discharged from the mixer and shaped into the desired form, such as by rolling into sheets and cutting into sticks, extruded into chunks, casting into pellets or the like.

Generally, the ingredients are mixed by first melting the gum base and adding it to the running mixer. The base may also be melted in the mixer itself. Color or emulsifiers may also be added at this time. A softener, such as glycerin, may also be added at this time, along with syrup and a portion of the bulking agent/sweetener. Further portions of the bulking agent/sweetener may then be added to the mixer. A flavoring agent is typically added with the final portion of the bulking agent/sweetener. A high-intensity sweetener is preferably added after the final portion of bulking agent and flavor has been added.

The entire mixing procedure typically takes from five to fifteen minutes, but longer mixing times may sometimes be required. Those skilled in the art will recognize that many variations of the above-described procedure may be followed.

Examples of the present invention are detailed below. The examples illustrate various embodiments of the present invention and thus are not intended to limit the scope of the present invention.

### EXAMPLES

### A. Acid-Base Reactions and the Formation of Soluble Minerals

Example 1

To a 250 ml beaker, 2 grams of adipic acid powder is dissolved in 50 grams of distilled water. Then, 2 grams of calcium carbonate powder (Vicron 25-11 FG from Specilaty Minerals, Inc.) are added. When stirred, the slurry foams, suggesting CO₂ evolution. After four hours, the slurry is filtered through a filter paper. 25 grams of the filtered solution is then dried. It contains 1.5 grams of solids (soluble calcium adipate).

Example 2

To a 250 ml beaker, 2 grams of tartaric acid powder is dissolved in 50 grams of distilled water. Then, 2 grams of calcium carbonate powder are added. When stirred, the slurry foams, suggesting CO₂ evolution. After four hours, the slurry is filtered through a filter paper. 25 grams of the filtered solution is then dried. It contains 0.15 grams of solids (soluble calcium tartrate).

Example 3

To a 250 ml beaker, 2 grams of malic acid powder is dissolved in 50 grams of distilled water. Then, 2 grams of calcium carbonate powder are added. When stirred, the slurry foams, suggesting CO₂ evolution. After four hours, the slurry is filtered through a filter paper. 25 grams of the filtered solution is then dried. It contains 0.5 grams of solids (soluble calcium malate).

Example 4

To a 250 ml beaker, 2 grams of citric acid powder is dissolved in 50 grams of distilled water. Then, 2 grams of calcium carbonate powder are added. When stirred, the slurry foams, suggesting CO₂ evolution. After four hours, the slurry is filtered through a filter paper. 25 grams of the filtered solution is then dried. It contains 0.15 grams of solids (soluble calcium citrate).

Example 5

To a 250 ml beaker, 2 grams of fumaric acid powder is dissolved in 50 grams of distilled water. Then, 2 grams of calcium carbonate powder are added. When stirred, the slurry foams, suggesting CO₂ evolution. After four hours, the slurry is filtered through a filter paper. 25 grams of the filtered solution is then dried. It contains 0.6 grams of solids (soluble calcium fumarate).

The water solubility sequence at ambient is:

| Calcium adipate | 6.0% |
|---|---|
| Calcium fumarate | 2.4% |
| Calcium malate | 2.0% |
| Calcium citrate | 0.6% |
| Calcium tartrate | 0.6% |

### B. Calcium Carbonate and Acid Reaction in Gum Bases

Example 6

To a 120 ml Sigma-blade mixer (Plasti-Corder Digi-System, C. W. Brabender Instruments, Inc., South Hackensack, N.J.) set at 39° C. and 50 rpm, 75 grams of ALPHA GRANDE bubble gum base (L. A. Dreyfus Company, Edison, N.J.) was kneaded in 120 grams of distilled water for 10 minutes. Then 3 grams of adipic acid (solid) was added. After 30 minutes of mixing, the fluid was discharged and filtered through a filter paper. After dried at 110° C. to effective completion, it was found that the fluid contained 2.84% of soluble calcium adipate. Further tests indicated that it was not soluble in methanol while adipic acid should be soluble in methanol. This process is believed to simulate the actual chewing process during chewing gum.

Example 7

To a 120 ml Sigma-blade mixer set at 39° C. and 50 rpm, 75 grams of ALPHA GRANDE bubble gum base was kneaded with 120 grams of distilled water for 10 minutes. Then 3 grams of fumaric acid (gum room) was added. After 30 minutes of mixing, the fluid was discharged and filtered though a filter paper. After being dried at 110° C. to effective completion, it was found that the fluid contained 1.19% of soluble calcium fumarate. Further tests indicated that it was not soluble in methanol while fumaric acid should be soluble in methanol. This process is believed to simulate the actual chewing process during chewing of gum.

Example 8

To a 120 ml Siam-blade mixer set at 39° C. and 50 rpm, 75 grams of DREYCO gum base (L. A. Dreyfus Company, Edison, N.J.) was kneaded with 120 grams of distilled water for 10 minutes. Then 3 grams of adipic acid was added. After 30 minutes of mixing, the fluid was discharged and filtered though a filter paper. After being dried at 110° C. to effective completion, it was found that the fluid contained 2.95% of soluble calcium adipate (tests indicated that it was not soluble in methanol while adipic acid should be soluble in methanol). This process is believed to simulate the actual chewing process during chewing of gum.

Example 9

To a 120 ml Sigma-blade mixer set at 39° C. and 50 rpm, 75 grams of DREYCO gum base was kneaded in 120 grams of distilled water for 10 minutes. Then 3 grams of fumaric acid was added. After 30 minutes of mixing, the fluid was discharged and filtered through a paper filter. After being dried at 110° C. to effective completion, it was found that the fluid contained 1.46% of soluble calcium fumarate (tests indicated that it was not soluble in methanol while fumaric acid should be soluble in methanol). This process is believed to simulate the actual chewing process during chewing of gum.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1. A mineral delivery system comprising a mineral delivery agent capable of releasing one or more minerals via an acid-base reaction between a mineral salt and an acid in an aqueous solution.

2. The mineral delivery system of claim 1, wherein the mineral salt is water-insoluble and the acid is a solid organic acid.

3. The mineral delivery system of claim 1, wherein the mineral salt is selected from the group consisting of calcium carbonate, copper carbonate hydroxide, magnesium carbonate hydroxide, manganese carbonate, zinc carbonate, zinc carbonate hydroxide and combinations thereof.

4. The mineral delivery system of claim 1, wherein the acid is selected from the group consisting of adipic acid, citric acid, fumaric acid, gluconic acid, lactic acid, malic acid, succinic acid, tartaric acid and combinations thereof.

5. The mineral delivery system of claim 1, wherein the mineral delivery agent includes the mineral salt in an amount ranging from about 0.1% by weight to about 60% by weight.

6. The mineral delivery system of claim 1, wherein the mineral delivery agent includes the acid in an amount ranging from about 0.1% by weight to about 30% by weight.

7. The mineral delivery system of claim 1, wherein the mineral salt comprises a powder that has an average particle size ranging from about 0.1 microns to about 200 microns.

8. The mineral delivery system of claim 1, wherein the acid comprises a powder that has an average particle size ranging from about 0.1 microns to about 500 microns.

9. The mineral delivery system of claim 1, wherein the mineral delivery agent is incorporated into an oral patch.

10. A mineral delivery system comprising a gum including a mineral carbonate and an acid allowing the gum to release one or more minerals into an individual's oral cavity via an acid-base reaction between the mineral carbonate and the acid during chewing of the gum.

11. The mineral delivery system of claim 10, wherein the mineral carbonate is incorporated into a gum base of the gum.

12. The mineral delivery system of claim 10, wherein the mineral carbonate is incorporated into the gum at a final gum processing stage.

13. The mineral delivery system of claim 10 wherein, the acid is incorporated into a gum base of the gum.

14. The mineral delivery system of claim 10 wherein, the acid is incorporated into the gum as a flavor component.

15. The mineral delivery system of claim 10 wherein, the acid is an encapsulated component of the gum.

16. The mineral delivery system of claim 10, wherein the mineral carbonate is selected from the group consisting of calcium carbonate, copper carbonate hydroxide, magnesium carbonate hydroxide, manganese carbonate, zinc carbonate, zinc carbonate hydroxide and combinations thereof and wherein the acid is selected from the group consisting of adipic acid, citric acid, fumaric acid, gluconic acid, lactic acid, malic acid, succinic acid, tartaric acid, and combinations thereof.

17. The mineral delivery system of claim 10, wherein the gum includes the mineral carbonate in an amount ranging from about 0.1 % by weight to about 60% by weight.

18. The mineral delivery system of claim 10, wherein the gum includes the acid in an amount ranging from about 0.1% by weight to about 30% by weight.

19. A method of releasing one or more minerals into an individual's oral cavity, the method comprising the steps of:
providing a mineral delivery agent including a mineral salt and an acid;
placing the mineral delivery agent in the individual's oral cavity; and
releasing the minerals via an acid-base reaction between the mineral carbonate and the acid in an aqueous solution.

20. The method of claim 19, wherein the minerals are released from a gum during chewing of same.

21. The method of claim 19, wherein the minerals are released from an oral patch containing the mineral delivery agent upon contact with saliva in the individual's oral cavity.

22. The method of claim 19, wherein the mineral salt is selected from the group consisting of mineral carbonates including calcium carbonate, copper carbonate hydroxide, magnesium carbonate hydroxide, manganese carbonate, zinc carbonate, zinc carbonate hydroxide and combinations thereof and wherein the acid is selected from the group consisting of adipic acid, citric acid, fumaric acid, gluconic acid, lactic acid, malic acid, succinic acid, tartaric acid and combinations thereof.

23. The method of claim 19, wherein the mineral delivery agent comprises a gum.

24. The method of claim 19, wherein the gum includes the mineral salt in an amount ranging from about 0.1% by weight to about 60% by weight.

25. The method of claim 19, wherein the gum includes the acid in an amount ranging from about 0.1% by weight to about 30% by weight.
